(19) United States
(12) Patent Application Publication
(10) Pub. No.: US 2013/0177241 A1
(43) Pub. Date: Jul. 11, 2013

(54) IMAGE PROCESSING APPARATUS AND METHOD THEREOF

(71) Applicant: Novatek Microelectronics Corp., Hsinchu (TW)

(72) Inventor: Chao-Tsung Huang, Kaohsiung City (TW)

(73) Assignee: NOVATEK MICROELECTRONICS CORP., Hsinchu (TW)

(21) Appl. No.: 13/778,163

(22) Filed: Feb. 27, 2013

Related U.S. Application Data
(62) Division of application No. 12/541,986, filed on Aug. 17, 2009.

(30) Foreign Application Priority Data
Jun. 22, 2009 (TW) 98120876

(51) Int. Cl. G06T 9/00

(52) U.S. Cl. CPC G06T 9/00
USPC 382/166

(57) ABSTRACT

An image processing apparatus and a method thereof are provided. The image processing apparatus includes a memory device and a first and a second image data transformation unit. A first image data is written into and read from the memory device. Each pixel value has a first data format. The first data format is compatible with a dedicated format accessible by the memory device. The first image data transformation unit transforms a second image data into the first image data. The second image data includes a plurality of pixel values each having a second data format. The second data format is not compatible with the dedicated format. The second image data transformation unit transforms the first image data into a third image data. The third image data includes a plurality of pixel values each having a third data format. The third data format is not compatible with the dedicated format.

### CROSS-REFERENCE TO RELATED APPLICATION

This application is a divisional application of and claims priority benefit of an U.S. application Ser. No. 12/541,986, filed on Aug. 17, 2009, now pending, which claims the priority benefit of Taiwan application serial no. 98120876, filed on Jun. 22, 2009. The entirety of each of the above-mentioned patent applications is hereby incorporated by reference herein and made a part of specification.

### BACKGROUND OF THE INVENTION

1. Field of the Invention

The present invention relates to an image processing apparatus and a method thereof, and more particularly to an image processing apparatus for image compression (encoding) and image decompression (decoding) and a method thereof.

2. Description of Related Art

Among multimedia and consumer electronics, an image processing is usually carried out on a digital photo frame, a display card or a digital camera. And the image compression standard JPEG is mostly adopted in the current market. With the advancement of technique, the committee of Joint Photographic Experts Group is considering to standardize a next-generation image compression standard JPEG-XR (JPEG Extended Range). Image data of various types of color space are supported in the image compression standard JPEG-XR, e.g. an sRGB color space or an scRGB color space.

In the sRGB color space, the data format of pixel values constituting an image data may be an 8 bits data format. And in the scRGB color space, the data format of pixel values constituting an image data may be a 16 bits data format. In detail, a Scaled_Flag may be adjusted during image processing based on the image compression standard JPEG-XR, such that the data format of the pixel values which is processed based on the image compression standard JPEG-XR is not always compatible with a multiple of 8 bits data format. Instead, the data format of the pixel values may be an 11 bits data format, a 12 bits data format, a 19 bits data format, or a 20 bits data format, etc.

Thus a memory device can not access efficiently during an image processing based on the image compression standard JPEG-XR due to the particular data format. That is to say, the particular data format is not compatible with the dedicated format accessible by the memory device, such that memory wastage occurs during the image processing.

### SUMMARY OF THE INVENTION

The present invention provides an image processing apparatus and a method thereof, in which the disadvantage in the related art is resolved.

The present invention provides an image processing apparatus which includes a memory device, a first image data transformation unit and a second image data transformation unit. A first pixel value including a plurality of first pixel values is written into and read from the memory device. Each of the first pixel values has a first data format, and the first data format is compatible with a dedicated format accessible by the memory device. The first image data transformation unit is coupled to the memory device. The first image data transformation unit is configured to receive a second image data including a plurality of second pixel values and process a first transformation, such that the first image data is obtained to be written into the memory device. Besides, each of the second pixel values has a second data format, and the second data format is not compatible with the dedicated format.

The second image data transformation unit is coupled to the memory device. The second image data transformation unit is configured to read the first image data from the memory device and process a second transformation, such that a third image data including a plurality of third pixel values is obtained. Each of the third pixel values has a third data format, and the third data format is not compatible with the dedicated format. In addition, the second pixel values are substantially corresponding to the third pixel values.

The present invention provides an image processing method which includes following steps. First, a first image data is provided, and the first image data has a plurality of first pixel values. Each of the first pixel values has a first data format, and the first data format is not compatible with a dedicated format accessible by a memory device. Next, a first transformation is executed on the first image data, such that a second image data is obtained to be written into the memory device. And each of the second image data has a plurality of second pixel values. Each of the second pixel values has a second data format, and the second data format is compatible with the dedicated format; and

Finally, when the second image data is read from the memory device, a second transformation is executed on the second image data such that a third image data including a plurality of third pixel values is obtained. Each of the third pixel values has a third data format, and the third data format is not compatible with the dedicated format. The first pixel values are substantially corresponding to the third pixel values.

The present invention further provides another image processing apparatus which includes a memory device, an image data operating transformation unit, and a second image data transformation unit. The image data transformation unit includes a first operator and a first image data transformation unit. A first pixel value including a plurality of first pixel values is written into and read form the memory device. Each of the first pixel values has a first data format, and the first data format is compatible with a dedicated format accessible by the memory device.

The first operator is configured to receive a second image data including a plurality of second pixel values and process a correcting process. Thus a third image data including a plurality of third pixel values is obtained, wherein each of the third pixel values is within a first predetermined range. Each of the second pixel values has a second data format, and the second data format is not compatible with the dedicated format. The first image data transformation unit is coupled to the first operator. In addition, the first image data transformation unit is configured to receive the third image data and process a first transformation, such that the first image data is obtained to be written into the memory device.

The second image data transformation unit is coupled to the memory device. The second image data transformation unit is configured to read the first image data from the memory device and process a second transformation, such that a fourth image data including a plurality of fourth pixel values is obtained. Each of the fourth pixel values has a third data format, and the third data format is not compatible with the dedicated format. In addition, the second pixel values are substantially corresponding to the fourth pixel values.

The present invention provides another image processing method which includes following steps. First, a first image data is provided, and the first image data has a plurality of first pixel values. Each of the first pixel values has a first data format, and the first data format is not compatible with a dedicated format accessible by a memory device. Next, a correcting process is executed on the first image data such that a second image data including a plurality of second pixel values is obtained, wherein each of the second pixel values is within a predetermined range.

Then, a first transformation is executed on the second image data, such that a third image data is obtained to be written into the memory device. And each of the third image data has a plurality of third pixel values. Each of the third pixel values has a third data format, and the third data format is compatible with the dedicated format accessible by the memory device. Finally, when the third image data is read from the memory device, a second transformation is executed on the third image data such that a fourth image data including a plurality of fourth pixel values is obtained. Each of the fourth pixel values has a fourth data format, and the fourth data format is not compatible with the dedicated format. The first pixel values are substantially corresponding to the fourth pixel values.

The present invention further provides another image processing apparatus which includes a memory device, a first image data transformation unit, a second image data transformation unit, an image data operating transformation unit, and a fourth image data transformation unit, wherein the image data operating transformation unit includes a first operator and a third image data transformation unit. A first pixel value including a plurality of first pixel values is written into and read from the memory device. Each of the first pixel values has a first data format, and the first data format is compatible with a dedicated format accessible by the memory device.

The first image data transformation unit is coupled to the memory device. The first image data transformation unit is configured to receive a second image data including a plurality of second pixel values and process a first transformation, such that the first image data is obtained to be written into the memory device. Besides, each of the second pixel values has a second data format, and the second data format is not compatible with the dedicated format. The second image data transformation unit is coupled to the memory device. The second image data transformation unit is configured to read the first image data from the memory device and process a second transformation, such that a third image data including a plurality of third pixel values is obtained. Each of the third pixel values has a third data format, and the third data format is not compatible with the dedicated format. In addition, the second pixel values are substantially corresponding to the third pixel values.

The first operator is configured to receive a fourth image data including a plurality of fourth pixel values and process a correcting process. Thus a fifth image data including a plurality of fifth pixel values is obtained, wherein each of the fifth pixel values is within a first predetermined range. Each of the fourth pixel values has a fourth data format, and the fourth data format is not compatible with the dedicated format. The third image data transformation unit is coupled to the first operator. In addition, the third image data transformation unit is configured to receive the fifth image data and process a third transformation, such that the first image data is obtained to be written into the memory device.

The fourth image data transformation unit is coupled to the memory device. The fourth image data transformation unit is configured to read the first image data from the memory device and process a fourth transformation, such that a sixth image data including a plurality of sixth pixel values is obtained. Each of the sixth pixel values has a sixth data format, and the sixth data format is not compatible with the dedicated format. In addition, the fourth pixel values are substantially corresponding to the sixth pixel values.

Accordingly, in image processing apparatus and the method of the present invention, when the data format the pixel value of the image data is not compatible with the dedicated format accessible by the memory, a transformation is carried out on the image data, such that the data format of the image data is transformed into the dedicated format. And then, after the image data with the dedicated format has been written or read, another transformation is carried out on the image data with the dedicated format, such that the data format of the image data after the transformations is substantially corresponding to that before the transformations.

It should be understood that the above general descriptions and following embodiments are only for explanation and presented as examples, but not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an image processing apparatus according to an exemplary embodiment of the present invention.

FIG. 2A is a block diagram of the image data processing unit in FIG. 1.

FIG. 2B is another block diagram of the image data processing unit in FIG.

FIG. 2C is another block diagram of the image data processing unit in FIG. 1.

FIG. 3 is a block diagram of the image encoder in FIG. 1.

FIG. 4 is a flowchart of an image processing method according to an exemplary embodiment of the present invention.

FIG. 5 is a block diagram of an image processing apparatus according to another exemplary embodiment of the present invention.

FIG. 6A is a block diagram of the image data processing unit 510 in FIG. 5.

FIG. 6B is another block diagram of the image data processing unit 510 in FIG. 5.

FIG. 7 is a block diagram of the image decoder 502 in FIG. 5.

FIG. 8 is a flowchart of an image processing method according to another exemplary embodiment of the present invention.

FIG. 9 is a block diagram of an image processing apparatus according to another exemplary embodiment of the present invention.

### DESCRIPTION OF EMBODIMENTS

According to implementation types of image processing apparatuses and methods thereof, exemplary embodiments of the present invention include an image compression (encoding) apparatus, an image compression method, an image decompression (decoding) apparatus, an image decompression method, and an image compression/decompression apparatus. Several embodiments are described according to each of the implementation types as following.

### Image Compression Apparatus

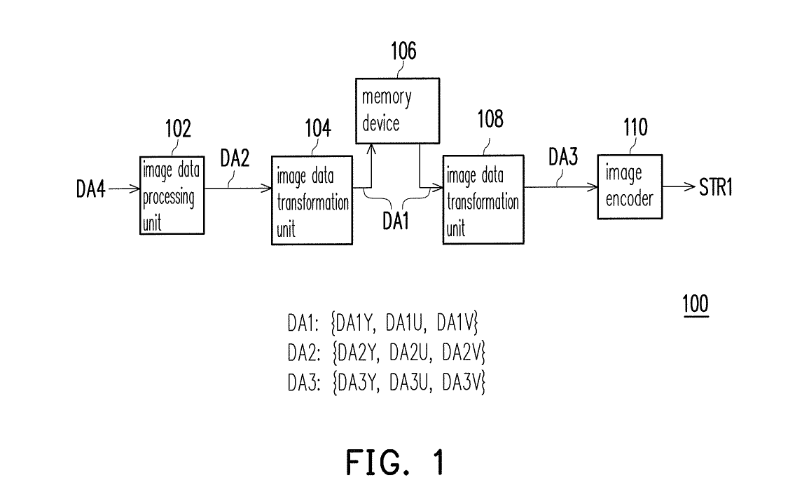

FIG. 1 is a block diagram of an image processing apparatus according to an exemplary embodiment of the present invention. Referring to FIG. 1, the image processing apparatus 100 includes an image data processing unit 102, image data processing units 104 and 108, a memory device 106 (e.g. a DRAM, but the present invention is not limited thereto), and an image encoder 110 (e.g. a JPEG-XR encoder, but the present invention is not limited thereto). An image data DA1 is able to be written into and read from the memory device 106, wherein the image data DA1 includes a plurality of pixel values.

The exemplary embodiment of the present invention takes three pixel values DA1Y, DA1U and DA1V as an example, each of the data formats of the pixel values DA1Y, DA1U and DA1V is a dedicated format, and the dedicated format is accessible by the memory device 106, for example, an 8 bits data format, 16 bits data format or a multiple of 8 bits data format.

On the other hand, an image processing product (e.g. a digital camera, but the present invention is not limited thereto) usually has the image data processing unit 102. The image data processing unit 102 is configured to receive an image data DA4 and process an image data processing, such that an image data DA2 is output. The image data DA2 includes a plurality of pixel values. The exemplary embodiment of the present invention takes three pixel values DA2Y, DA2U and DA2V as an example. Since the image data processing processed by the image data processing unit 102 may include color transformation or other relevant operation processing, the data formats of the pixel values DA2Y, DA2U and DA2V are usually not fit the dedicated format.

According to the related art mentioned above, when the data format of a written data is not compatible with the data format accessible by the memory device 106, memory wastage may occur during an image data processing. In order to prevent the memory wastage when the image data DA2 is written into the memory device 106, each of the pixel values of the image data DA2 is transformed into the dedicated format accessible by the memory device 106. Then the image data DA2 is written into the memory device 106. In detail, the image data transformation unit 104 processes a first transformation on the image data DA2, such that the image data DA1 is obtained. And the data formats of the pixel values DA1Y, DA1U and DA1V are compatible with the dedicated format accessible by the memory device 106.

Besides, since the image data transformation unit 104 has completed the first transformation on the image data DA2, the data format of the image data DA1 stored in the memory device 106 requires being recovered when the image data DA1 is read from the memory device 106. Specifically, the image data transformation unit 108 processes a second transformation on the image data DA1 after the image data transformation unit 108 reads the image data DA1 from the memory device 106, such that an image data DA3 is obtained. The image data DA3 includes a plurality of pixel values, and the exemplary embodiment of the present invention takes three pixel values DA3Y, DA3U and DA3V as an example. Each of the data formats of the pixel values DA3Y, DA3U and DA3V is not compatible with the dedicated format. More particularly, after the first transformation and the second transformation has been carried out on the image data DA2; the pixel values of the image data DA2 are substantially corresponding to the pixel values of the image data DA3.

On the other side, the image data DA3 obtained by the image processing apparatus 100 is able to be provided for any additional processing, e.g. being displayed on a screen, being written into a storage device, or for encoding processing. The image processing apparatus 100 of the exemplary embodiment includes an image encoder 110. The image encoder 110 encodes the image data DA3 such that a bit stream STR1 is output.

Accordingly, the image data processing unit 102 receives an image data DA4 and process an image data processing, such that the image data DA2 is output. In order to prevent the memory wastage, the image data transformation unit 104 processes the first transformation on the image data DA2, such that the image data DA1 is obtained. And the data format of each of the pixel values of the image data DA1 is compatible with the dedicated format accessible by the memory device 106.

In addition, since the first transformation has been carried out on the image data DA2, the second transformation requires being carried out on the image data DA1 after the image data DA1 is read from the image data transformation unit 108, such that the recovered image data DA3 is obtained. And the pixel values of the image data DA2 are substantially corresponding to the pixel values of the image data DA3. In detail, the data formats of the image data DA2 and the image data DA4 may include different types of data formats. In order to fit different types of data formats, the first transformation processed by the image data transformation unit 104 is also adjusted accordingly.

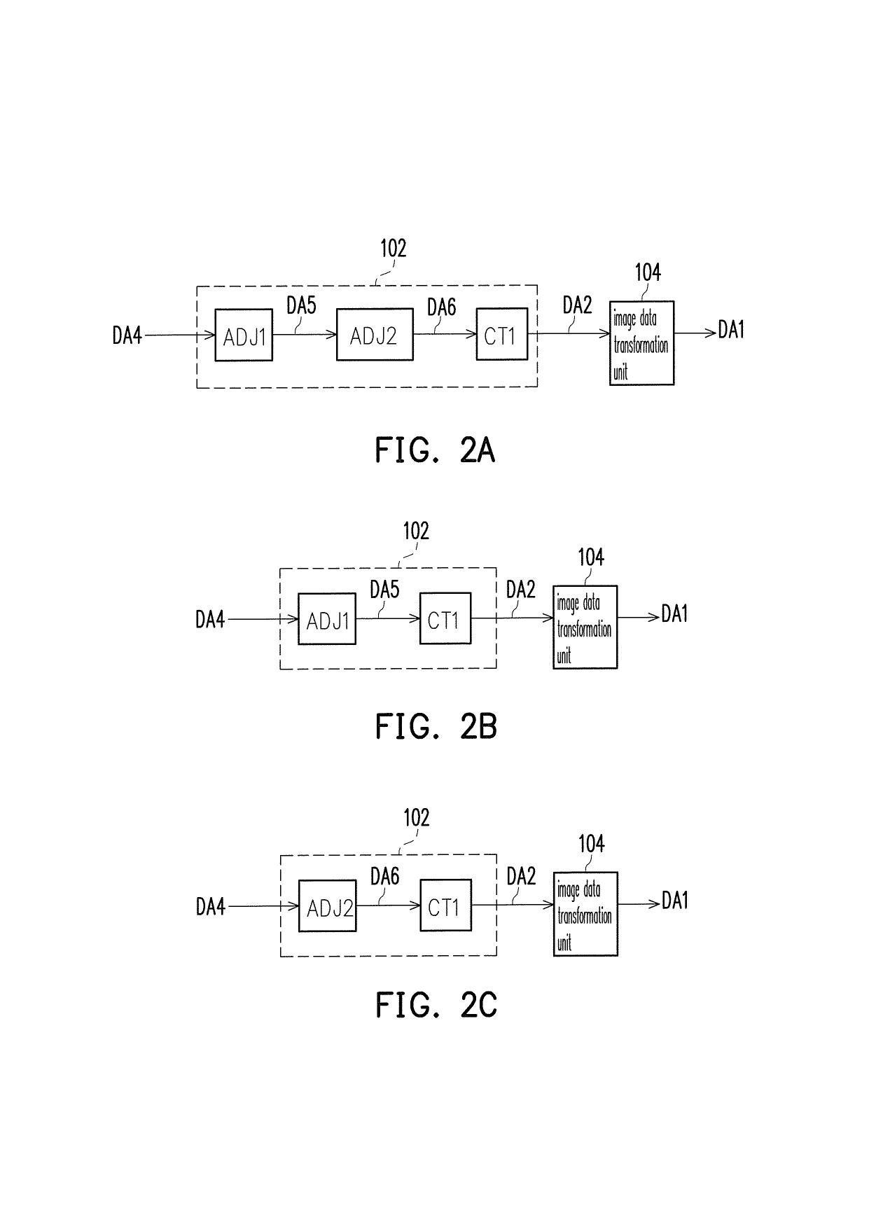

FIG. 2A is a block diagram of the image data processing unit in FIG. 1. Referring to both FIG. 1 and FIG. 2A, the image data processing unit 102 includes an operator ADJ1, an operator ADJ2, and a color transducer CT1. The image data DA4 received by the image data processing unit 102 includes a plurality of pixel values, i.e. the pixel values DA4R, DA4G, and DA4B. In the exemplary embodiment of the present invention, it is assumed that the data formats of the pixel values DA4R, DA4G, and DA4B are all 8 bits data formats. And the dedicated format accessible by the memory device 106 is also an 8 bits data format.

Accordingly, if a Scaled_Flag is adjusted, e.g. Scaled_Flag=1, according to an image compression standard JPEG-XR during an image compression, a data format of the pixel value which is processed is not a multiple of 8 bits data format. More particularly, since the image data DA4 is processed by the operator ADJ1 such that an image data DA5 is obtained. And each of data values of the image data DA5 is not a multiple of 8 bits data format, for example, an 11 bits or 12 bits data formats, etc.

In the exemplary embodiment, the operator ADJ1 multiplies each of the pixel values of the image data DA4 by a first ratio value, such that the image data DA5 is obtained. The first ratio value may be 8, and the data formats of each of the pixel values of the image data DA5 is an 11 bits format. Next, the operator ADJ2 subtracts a first value from each of the pixel values of the image data DA5 such that an image data DA6 is obtained. And the first value may be 1024. Then, the color transducer CT1 processes a color transformation on the image data DA6, such that the image data DA2 is obtained. The color transformation in which a RGB color space is transformed into a YUV color space. At this moment, the pixel value DA2Y is an 11 bits data format, and the pixel values DA2U and DA2V are both 12 bits data formats.

To prevent the memory wastage when the image data DA2 is written into the memory device 106, the image data transformation unit 104 processes the first transformation on the image data DA2. And the first transformation may be provided according to following descriptions. For example, the pixel values to be processed may be divided by a second ratio value in the first transformation, e.g. DA1Y=DA2Y/8, DA1U=DA2U/16, and DA1V=DA2V/16. The results of the pixel values to be processed dividing by a second ratio value may be rounded off in the first transformation. The results of the pixel values to be processed dividing by a second ratio value may be rounded up in the first transformation. The results of the pixel values to be processed dividing by a second ratio value may be rounded down in the first transformation. In the first transformation, p least significant bits (LSBs) of the pixel value to be processed may be discarded. For instance, the pixel value DA1Y is the result of the pixel value DA2Y discarding 3 LSBs, the pixel value DA1U is the result of the pixel value DA2U discarding 4 LSBs, and the pixel value DA1V is the result of the pixel value DA2V discarding 4 LSBs.

Accordingly, the data formats of the pixel values DA1Y, DA and DA are 8 bits data formats which are compatible with the dedicated format.

On the other side, in order to recover the image data DA1 read from the memory device 106, the image data transformation unit 108 processes the second transformation on the image data DA1, such that the image data DA3 is obtained. The second transformation may be provided according to following descriptions. For example, the pixel values to be processed may be multiplied by the second ratio value in the second transformation, e.g. DA3Y=DA1Y*8, DA3U=DA1U*16, and DA3Y=DA1Y*16. Thus each of the pixel values of the image data DA2 is substantially corresponding to the pixel values of the image data DA3.

FIG. 2B is another block diagram of the image data processing unit in FIG. 1. Referring to both FIG. 1 and FIG. 2B, the image data processing unit 102 includes an operator ADJ1 and a color transducer CT1. In the exemplary embodiment of the present invention, it is assumed that the data formats of the pixel values DA4R, DA4G, and DA4B are all 16 bits data formats. And the dedicated format accessible by the memory device 106 is also a 16 bits data format.

Accordingly, if Scaled_Flag=1, each of the pixel values of the image data DA5 is not a multiple of 8 bits data format during an image processing. In detail, the operator ADJ1 multiplies each of the pixel values of the image data DA4 by a third ratio value, such that the image data DA5 is obtained. The first ratio value may be 8, and the data formats of each of the pixel values of the image data DA5 is a 19 bits data format. Then, the color transducer CT1 processes a color transformation on the image data DA5, such that the image data DA2 is obtained. The color transformation in which a RGB color space is transforms into a YUV color space. At this moment, the pixel value DA2Y is a 19 bits data format, and the pixel values DA2U and DA2V are both 20 bits data format.

In order to prevent the memory wastage, the image data transformation unit 104 processes the first transformation on the image data DA2, wherein the implantations of the first transformation are as previously mentioned. In other words, the data formats of the pixel values DA1Y, DA1U and DA1V are 16 bits data formats, which are compatible with the dedicated format accessible by the memory device 106. Specifically, in order to recover the image data DA1 read from the memory device 106, the image data transformation unit 108 processes the second transformation on the image data DA1, such that the image data DA3 is obtained. The implantation of the second transformation can be referred to the aforementioned descriptions. As a result, each of the pixel values of the image data DA2 is substantially corresponding to the pixel values of the image data DA3.

FIG. 2C is another block diagram of the image data processing unit in FIG. 1. Referring to both FIG. 1 and FIG. 2C, the image data processing unit 102 includes an operator ADJ2 and a color transducer CT1. In the exemplary embodiment, the Scaled_Flag=0, and it is assumed that the data formats of pixel values DA4R, DA4G, and DA4B are all 8 bits data formats. Besides, the dedicated format is also an 8 bits data format.

Accordingly, the operator ADJ2 subtracts a first value from each of the pixel values of the image data DA4 such that an image data DA6 is obtained. And the first value may be 128. Then, the color transducer CT1 processes a color transformation on the image data DA6, such that the image data DA2 is obtained. The color transformation in which a RGB color space is transforms into a YUV color space. At this moment, the pixel value DA2Y is an 8 bits data format, and the pixel values DA2U and DA2V are both 9 bits data formats.

In order to prevent memory wastage, the image data transformation unit 104 processes the first transformation on the image data DA2, wherein the implantation of the first transformation may be carried out according to following descriptions. For example, the pixel values to be processed may be divided by a second ratio value in the first transformation, e.g. DA1U=DA2U/2, DA1V=DA2V/2, and DA1Y=DA2Y. The results of the pixel values to be processed divided by the second ratio value may be rounded off in the first transformation. The results of the pixel values to be processed being divided by the second ratio value may be rounded up in the first transformation. The results of the pixel values to be processed being divided by the second ratio value may be rounded down in the first transformation. In the first transformation, p least significant bits (LSBs) of the pixel value to be processed may be discarded. For instance, the pixel value DA1U is the result of the pixel value DA2U discarding 1 LSB, the pixel value DA1V is the result of the pixel value DA2V discarding 1 LSB, and the pixel value DA1Y is the result of the pixel value DA2Y without discarding an LSB.

Accordingly, the data formats of the pixel values DA1Y, DA1U and DA1V are 8 bits data formats which are compatible with the dedicated format accessible by the memory device 106.

On the other side, in order to recover the image data DA1 read from the memory device 106, the image data transformation unit 108 processes the second transformation on the image data DA1, such that the image data DA3 is obtained. The second transformation may be provided according to following descriptions. For example, the pixel values to be processes may be multiplied by the second ratio value in the second transformation, e.g. DA3U=DA1U*2, DA3Y=DA1Y*2, and DA3Y=DA1Y. In detail, the pixel values of the image data DA2 are substantially corresponding to the pixel values of the image data DA3.

And the image data DA3 obtained by the image processing apparatus 100 is able to be provided for any additional processing, e.g. being displayed on a screen, being written into a storage device, or for encoding. In the exemplary embodiment, the image encoder 110 is able to be implemented in various image compression standards. The image encoder may be a JPEG-XR encoder.

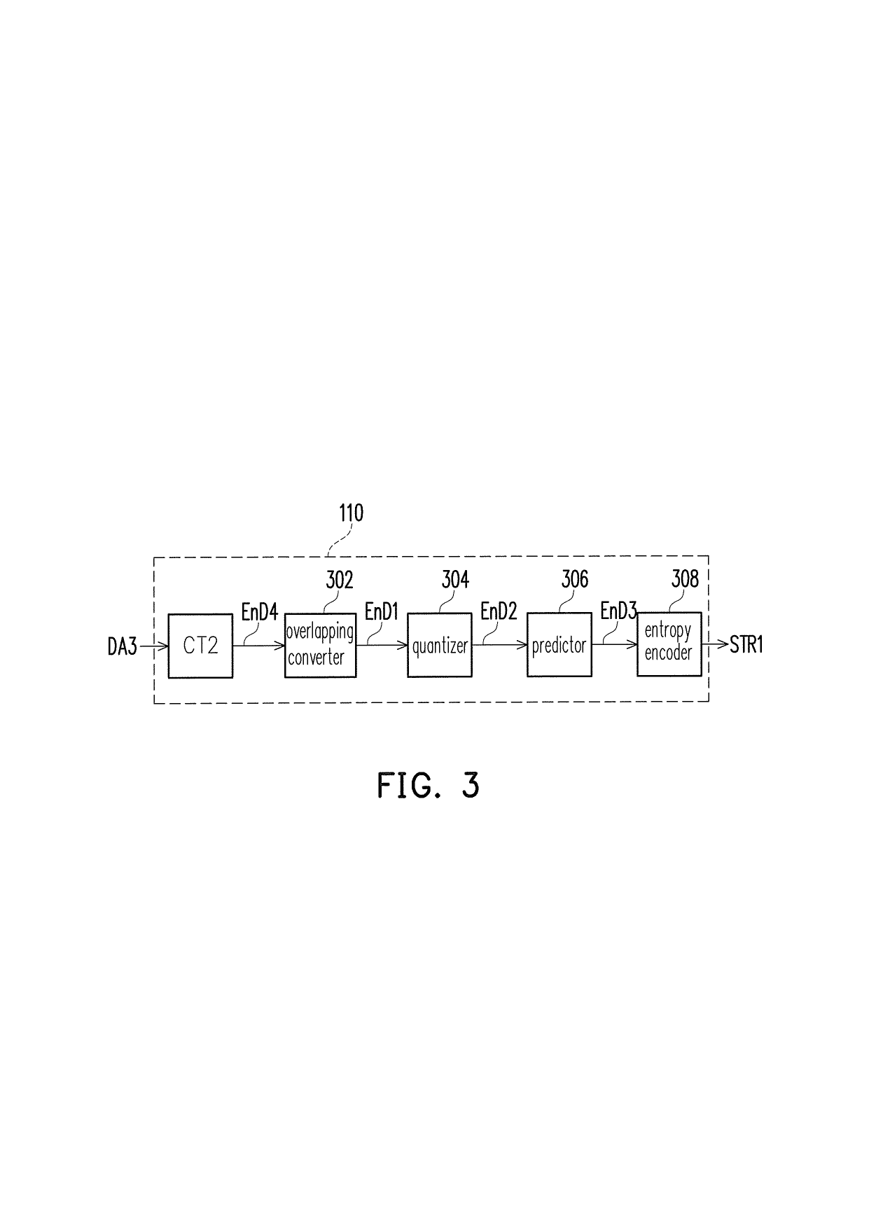

FIG. 3 is a block diagram of the image encoder in FIG. 1. Referring to both FIG. 1 and FIG. 3, the image encoder 110 includes a color transducer CT2, an overlapping converter 302, a quantizer 304, a predictor 306, and an entropy encoder 308. The color transducer CT2 processes a color transformation on the image data DA3, such that an encoded data EnD4 is output. The overlapping converter 302 processes a two-level lapped transformation on the encoded data EnD4, and output an encoded data EnD1.

The quantizer 304 processes a quantization on the encoded data EnD1, such that an encoded data EnD2 is output. The quantizer 306 processes a prediction on the encoded data EnD2, such that an encoded data EnD3 is output. The entropy encoder 308 processes an entropy encoding on the encoded data EnD3, such that a bit stream is output. In another exemplary embodiment of the present invention, the color transducer CT2 of the image encoder 110 may be omitted based on the real design requirement. And the bit stream STR1 is able to be obtained as well by processing an encoding on the image data DA3.

### Image Compression Method

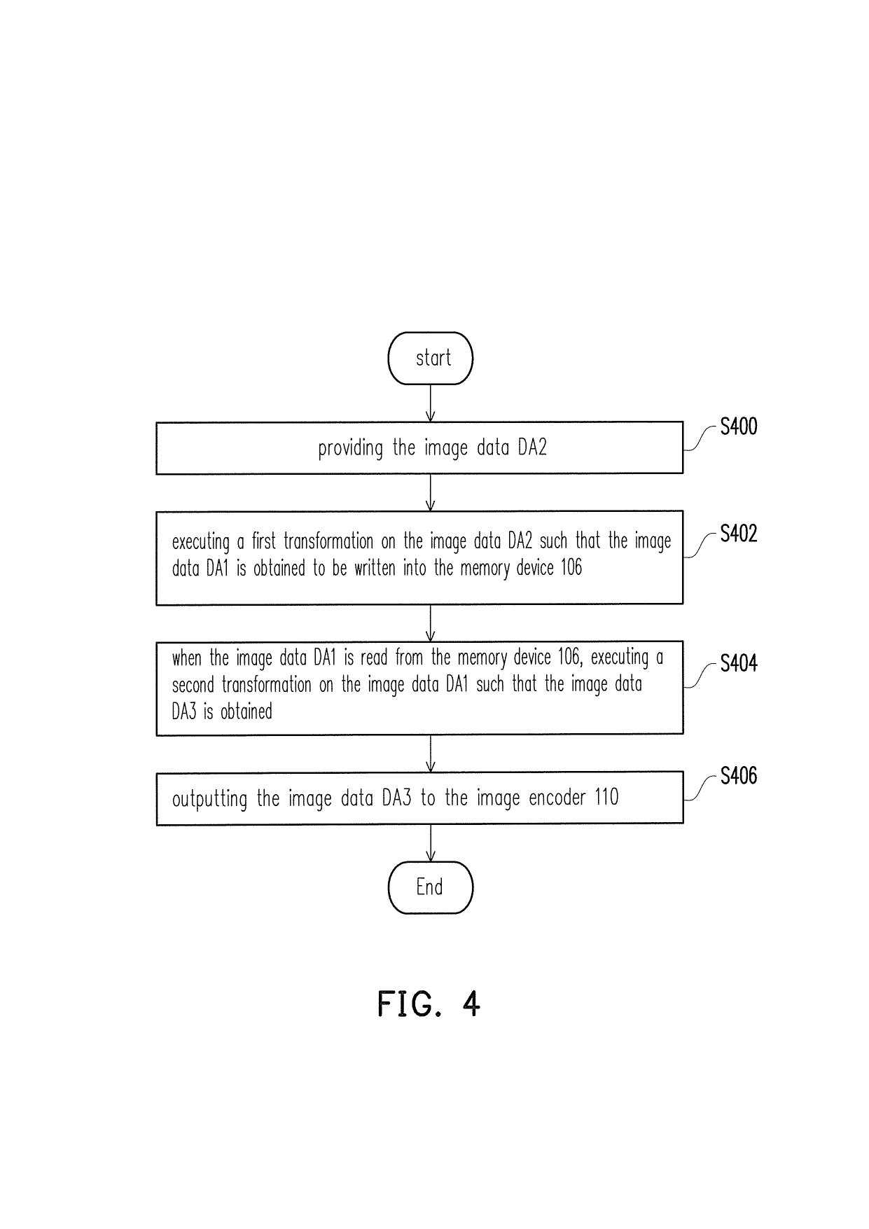

Based on the description of the embodiment of FIG. 1, FIG. 4 is a flowchart of an image processing method according to an exemplary embodiment of the present invention. Referring to FIG. 1 to FIG. 4, the image processing method of the exemplary embodiment includes following steps. First, the image data DA2 is provided (step S400), and the image data DA2 has a plurality of second pixel values. Each of the second pixel values has the second data format, and the second data format is not compatible with the dedicated format accessible by the memory device 106. Next, a first transformation is executed on the image data DA2, such that the image data DA1 is obtained to be written into the memory device 106 (step S402). And each of the image data DA1 has a plurality of first pixel values. Each of the first pixel values has the first data format, and the first data format is compatible with the dedicated format.

Then when the image data DA1 is read from the memory device 106, a second transformation is executed on the image data DA1 such that the image data DA3 including a plurality of third pixel values is obtained (step S404). Each of the third pixel values has the third data format, and the third data format is not compatible with the dedicated format. The first pixel values are substantially corresponding to the third pixel values. Finally, the image data DA3 is output to the image encoder 110 (step S406).

In the exemplary embodiment, the implementations of the first and second transformations respectively mentioned in the steps S402 and S404 can be referred to the aforementioned embodiments. Thus no further descriptions are provided hereinafter.

### Image Decompression Apparatus

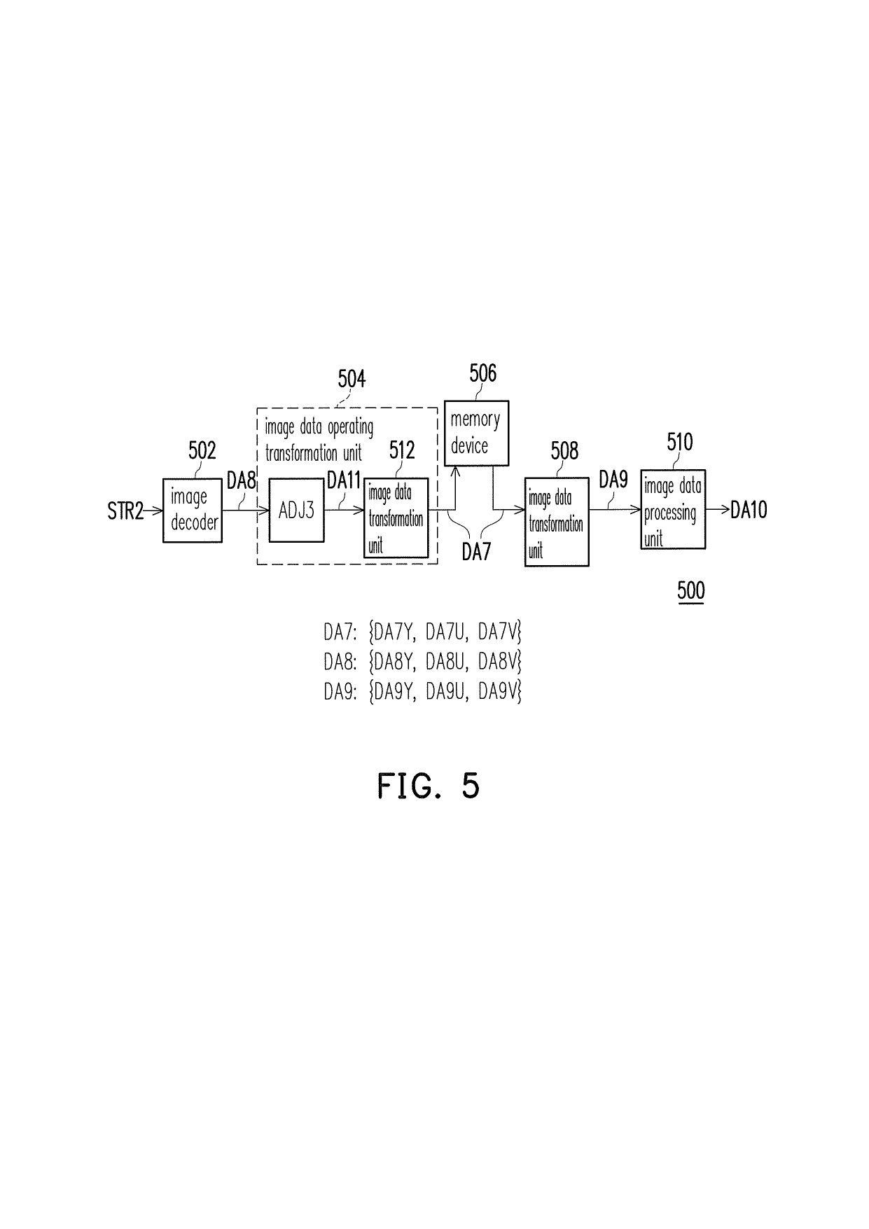

FIG. 5 is a block diagram of an image processing apparatus according to another exemplary embodiment of the present invention. Referring to FIG. 5, the image processing apparatus 500 includes an image decoder 502 (e.g. a JPEG-XR decoder, but the present invention is not limited thereto), an image data operating transformation unit 504, a memory device 506 (e.g. a DRAM, but the present invention is not limited thereto), an image data transformation unit 508, and an image data processing unit 510, wherein the image data operating transformation unit 504 includes an operator ADJ3 and an image data transformation unit 512.

An image data DA7 is able to be written into and read from the memory device 506, wherein the image data DA7 includes a plurality of pixel values. In the exemplary embodiment of the present invention, take three pixel values DA7Y, DA7U and DA7V as an example, each of the data formats of the pixel values DA7Y, DA7U and DA7V is a dedicated format, and the dedicated format is accessible by the memory device 506, for example, a 8 bits data format, a 16 bits data format or a multiple of 8 bits data format.

An image processing product (e.g. a digital camera, but the present invention is not limited thereto) usually has the image decoder 502. Besides, the image decoder 502 is configured to receive a bit stream STR2 and process an image decoding, such that an image data DA8 is obtained. And the image data DA8 includes a plurality of pixel values, e.g. pixel values DA8Y, DA8U and DA8V.

If the image decoder 502 uses an image decompression technique based on the image compression standard JPEG-XR, the data format of each of the pixel values of image data DA8 usually is not compatible with the dedicated format accessible by the memory device 506. According to the related art mentioned above, when the data format of a written data is not compatible with the data format accessible by the memory device 506, memory wastage may occur during an image data processing. In order to prevent memory wastage when the image data DA8 is written into the memory device 506, the image data operating transformation unit 504 transforms the image data DA8 into an image data DA7 ahead. And the data format of the image data DA7 is compatible with the dedicated format accessible by the memory device 506.

During the image decompression based on the image compression standard JPEG-XR, the image data DA8 may not correspond to a real color space due to quantization or inverse quantization. Thus in the exemplary embodiment, a correcting process is carried out on the image data DA8 by the operator ADJ3, such that an image data DA11s obtained. The correcting process may be a saturation process. In other words, when a pixel value of the image data DA8 falls outside of a first predetermined range, the correcting process is carried out on the pixel value, such that each of pixel values of the image data DA11 is within the first predetermined range.

Regarding the correcting process carried out by the operator ADJ3, more specifically, it is assumed that the data format of the pixel value DA8Y of the image data DA8 is a 19 bits data format, and the pixel value DA8Y is a positive integer and 0≦DA8Y≦524287. And the positive integers that are greater than or equal to 0 and smaller than or equal to 524287 are within the first predetermined range. In the exemplary embodiment, the pixel value DA8Y obtained by the image decoder 502 may be smaller than 0 or greater than 524287. At this moment, the operator ADJ3 processes the correcting process on the pixel value that falls outside of a first predetermined range, such that each of the pixel values of the image data DA11output by the operator ADJ3 is within the first predetermined range. However, the first predetermined range is not limited to the positive integers that are greater than or equal to 0 and smaller than or equal to 524287.

In detail, after the correcting process, the data format of each of the pixel values of the image data DA11 usually is not compatible with the dedicated format. Thus the image data transformation unit 512 processes a first transformation on the image data DA11, such that an image data DA7 is obtained, wherein the data format of each of pixel values DA7Y, DA7U and DA7V is the dedicated format.

Besides, in the exemplary embodiment, since the correcting process and the first transformation have been carried out on the image data DA7, a recovering process is performed on the image data DA7 after the image data DA7 is read from the memory device 506. Specifically, the image data transformation unit 508 processes a second transformation on the image data DA7 which is read from the memory device 506, such that an image data DA9 is obtained.

The pixel values in the exemplary embodiment of the present invention are three pixel values DA9Y, DA9U and DA9V, for example, wherein the pixel values of the image data DA9 are substantially corresponding to the pixel values of the image data DA8. More particularly, the image data DA9 obtained by the image data transformation unit 508 is able to be provided for any additional processing, e.g. being displayed on a screen, being written into a storage device, or for other processing. In the exemplary embodiment, the image processing apparatus 500 includes an image data processing unit 510 configured to receive the image data DA9 and process an image data processing, such that an image data DA10 is output.

Accordingly, the image decoder 502 receives a bit stream STR2 and processes an image decoding, such that the image data DA8 is obtained. In order to prevent memory wastage, the image data transformation unit 504 processes the correcting process and the first transformation on the image data DA8, such that the image data DA7 is obtained. And the data format of each of the pixel values of the image data DA7 is compatible with the dedicated format accessible by the memory device 506.

In addition, since the first transformation has been carried out on the image data DA8, the second transformation requires being carried out on the image data DA7 after the image data transformation unit 508 reads the image data DA7 from the memory device 506, such that the recovered image data DA9 is obtained. Thus pixel values of the image data DA9 are substantially corresponding to the pixel values of the image data DA8. Besides, in order to fit different types of data formats, the image decoder 502 is able to output image data in different data formats and the first transformation processed by the image data transformation unit 504 is also adjusted accordingly.

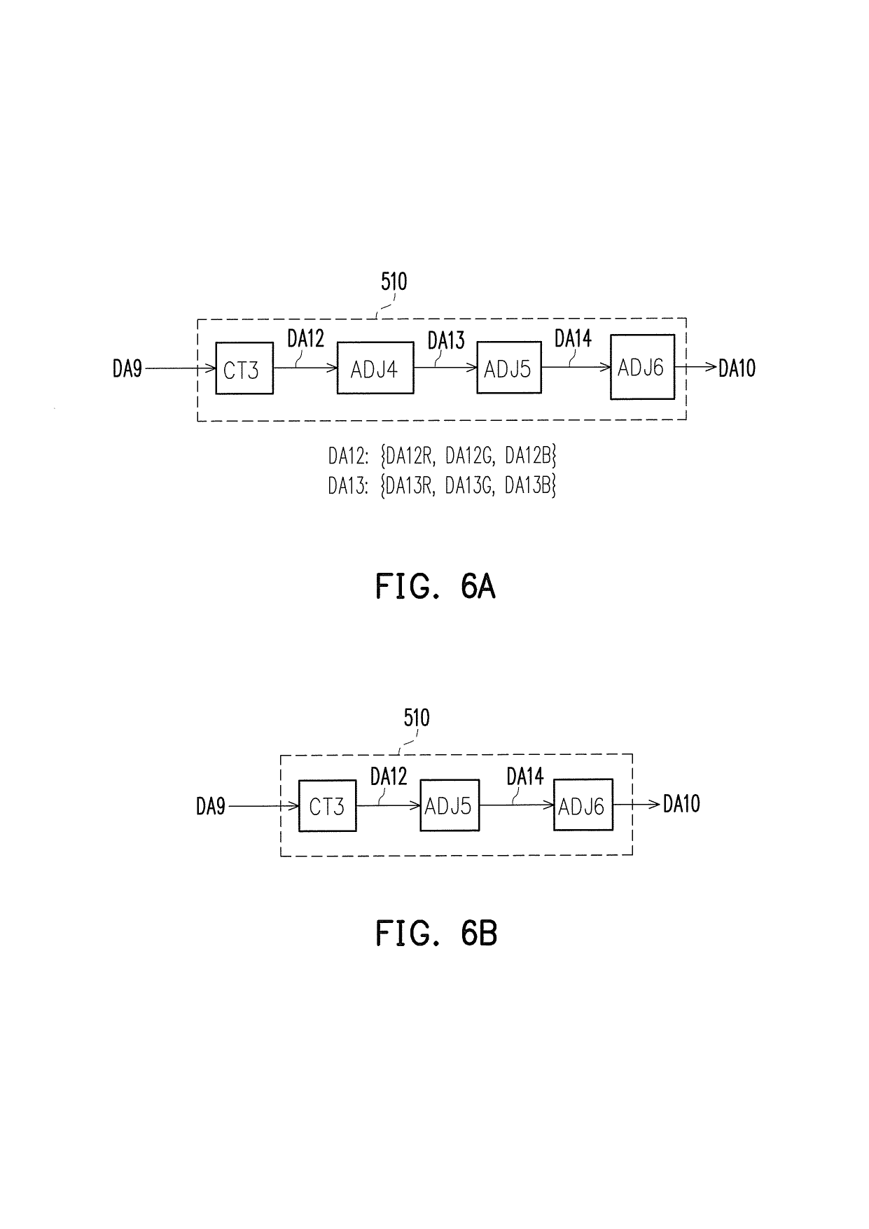

FIG. 6A is a block diagram of the image data processing unit 510 in FIG. 5. Referring to both FIG. 5 and FIG. 6A, it is assumed that the dedicated format accessible by the memory device 506 is an 8 bits data format. The data format of the pixel value DA8Y is an 11 bits data format, and the data format of the pixel values DA8U and DA8V are 12 bits data formats which are not compatible with the dedicated format.

In order to prevent memory wastage when the image data DA8 is written into the memory device 506, the image data transformation unit 512 processes the first transformation on the image data DA11. The first transformation may be provided according to following descriptions. For example, the pixel values to be processes may be divided by a second ratio value in the first transformation, e.g. DA7Y=DA11Y/8, DA7U=DA11U/16, and DA7V=DA11V/16. The results of the pixel values to be processed being divided by the second ratio value may be rounded off in the first transformation. The results of the pixel values to be processed being divided by a second ratio value may be rounded up in the first transformation. The results of the pixel values to be processed being divided by the second ratio value may be rounded down in the first transformation. In the first transformation, p least significant bits (LSBs) of the pixel value to be processed may be discarded. For instance, the pixel value DA7Y is the result of the pixel value DA1 1 Y discarding 3 LSBs, the pixel value DA7U is the result of the pixel value DA11U discarding 4 LSBs , and the pixel value DA7V is the result of the pixel value DA11V discarding 4 LSBs.

Accordingly, the data formats of the pixel values DA7Y, DA7U and DA7V are 8 bits data formats which are compatible with the dedicated format accessible by the memory device 506.

In order to recover the image data DA7 read from the memory device 506, the image data transformation unit 508 processes a second transformation on the image data DA7. The second transformation may be provided according to following descriptions. For example, the pixel values to be processes may be multiplied by the first ratio value in the second transformation, e.g. DA9Y=DA7Y*8, DA9U=DA7U*16, and DA9Y=DA7Y*16. At this time, the data format of the pixel value DA9Y is an 11 bits data format, and the data format of the pixel values DA9U and DA9V are 12 bits data formats, wherein the pixel values of the image data DA9 are substantially corresponding to the pixel values of the image data DA8.

In the exemplary embodiment, according to the data format of each of the pixel values of the image data DA9, the image data DA9 is able to be provided for any additional processing, e.g. being displayed on a screen, being written into a storage device, or for other processing. Referring to FIG. 6A, the image data processing unit 510 includes a color transducer CT3 and operators ADJ4˜ADJ6. The color transducer CT3 processes a color transformation on the image data DA9, such that an image data DA12 is output. A YUV color space is able to be transformed into a RGB color space in the color transformation. In the exemplary embodiment, the image data DA12 includes a plurality of pixel values, e.g. the pixel values DA12R, DA12G and DA12B. And the data formats of pixel values DA12R, DA12G, and DA12B are all 11 bits data formats.

The operator ADJ4 adds a first value to each of the pixel values of the image data DA12 such that an image data DA13 is output, wherein the first value may be 1024. The operator ADJ5 processes a correcting process on the image data DA13, such that each of pixel values of image data DA14 is within a second predetermined range. The operator ADJ6 divides each of the pixel values of the image data DA4 by a third ratio value, such that an image data DA10 is obtained, wherein the third ratio value may be 8.

Regarding the correcting process carried out by the operator ADJ5, more specifically, it is assumed that the image data DA13 includes a plurality of pixel values, e.g. three pixel values DA13R, DA13G and DA13B. Besides, it is assumed that the data format of the pixel value DA13R is an 11 bits data format, and the pixel value DA13R is a positive integer and 0≦DA13R≦2047. In addition, the positive integers that are greater than or equal to 0 and smaller than or equal to 2047 are within the second predetermined range. In the exemplary embodiment, the pixel value DA13R obtained by the operator ADJ4 may be smaller than 0 or greater than 2047. At this moment, the operator ADJ5 processes the correcting process on the pixel value DA13R, such that each of the pixel values of the image data DA14 output by the operator ADJ5 is within the second predetennined range. However, the second predetermined range is not limited to the positive integers that are greater than or equal to 0 and smaller than or equal to 2047.

FIG. 6B is another block diagram of the image data processing unit 510 in FIG. 5. Referring to both FIG. 5 and FIG. 6B, it is assumed that the dedicated format accessible by the memory device 506 is a 16 bits data format. The data format of the pixel value DA8Y is a 19 bits data format, and the data format of the pixel values DA8U and DA8V are both 20 bits data formats which are not compatible with the dedicated format.

In order to prevent memory wastage when the image data DA8 is written into the memory device 506, the image data transformation unit 512 processes the first transformation on the image data DA11, wherein the first transformation may be provided according to the aforementioned descriptions. In other words, the data formats of the pixel values DA7Y, DA7U and DA7V are all 16 bits data formats, which are compatible with the dedicated format accessible by the memory device 506.

To be more specific, in order to recover the image data DA7 read from the memory device 506, the image data transformation unit 508 processes a second transformation on the image data DA7. The implantation of the second transformation can be referred to the aforementioned descriptions. At this time, the data format of the pixel value DA9Y is a 19 bits data format, and the data format of the pixel values DA9U and DA9V are 20 bits data formats, wherein the pixel values of the image data DA9 are substantially corresponding to the pixel values of the image data DA8.

Furthermore, according to the data format of each of the pixel values of the image data DA9, the image data DA9 is able to be provided for any additional processing. Referring to FIG. 6B, the image data processing unit 510 includes a color transducer CT3, an operator ADJ5 and an operator ADJ6. The color transducer CT3 processes a color transformation on the image data DA9, such that an image data DA12 is output. A YUV color space is able to be transformed into a RGB color space in the color transformation. And the data formats of pixel values DA12R, DA12G, and DA12B are all 19 bits data formats. Moreover, the operator ADJ5 processes a correcting process on the image data DA12, such that each of the pixel values of image data DA14 is within a third predetermined range. The operator ADJ6 divides each of the pixel values of the image data DA14 by a third ratio value, such that an image data DA10 is obtained, wherein the third ratio value may be 8.

Regarding the correcting process carried out by the operator ADJ5, more specifically, it is assumed that the data format of the pixel value DA12R is a 19 bits data format, and the pixel value DA12R is an integer and −262144≦DA12R≦262143. And the integers that are greater than or equal to −262144 and smaller than or equal to 262143 are within the third predetermined range. In the exemplary embodiment, the pixel value DA12R obtained by the color transducer CT3 may smaller than −262144, or greater than 262143. At this moment, the operator ADJ5 processes the correcting process on the pixel value DA12R which falls outside of the third predetermined range, such that each of the pixel values of the image data DA12 output by the operator ADJ5 is within the third predetermined range. However, the third predetermined range is not limited to the integers that are greater than or equal to −262144 and smaller than or equal to 262143.

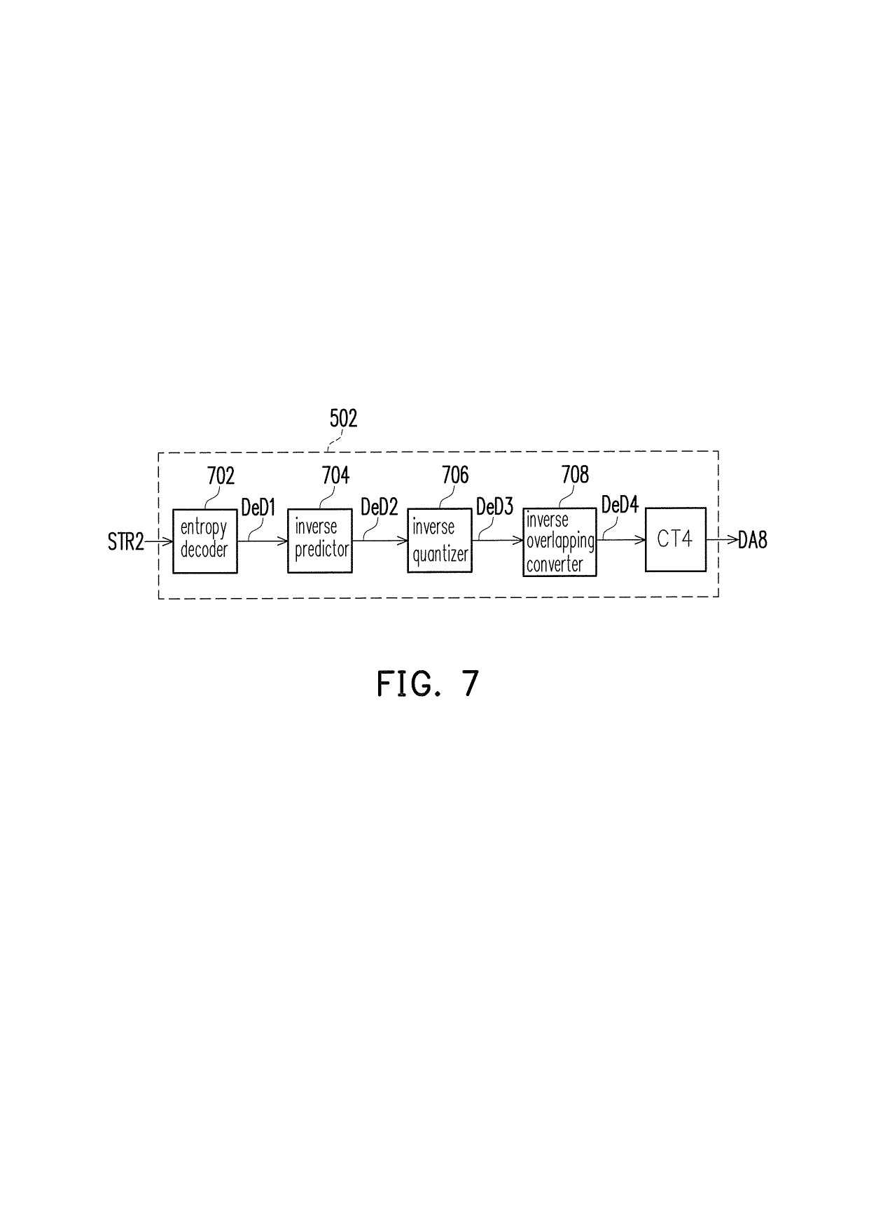

The image decoder 502 of the image processing apparatus 500 is able to adopt various image compression standards, such that image decoding is achieved. The image decoder 502 may be a JPEG-XR decoder. FIG. 7 is a block diagram of the image decoder 502 in FIG. 5. Referring to FIG. 7, the image decoder 502 includes an entropy decoder 702, an inverse predictor 704, an inverse quantizer 706, an inverse overlapping converter 708, and an overlapping converter CT4. The entropy decoder 702 processes an entropy decoding on the bit stream STR2, such that a decoded data DeD1 is output.

The inverse predictor 704 processes an inverse prediction on the decoded data DeD1, such that a decoded data DeD2 is output. The inverse quantizer 706 processes an inverse quantization on the decoded data DeD2, such that a decoded data DeD3 is output. The inverse overlapping converter 708 processes a two-level lapped inverse transformation on the decoded data DeD3, and output a decoded data DeD4. The color transducer CT4 processes a color transformation on the decoded data DeD4, such that an image data DA8 is output.

In another exemplary embodiment of the present invention, the color transducer CT4 of the image decoder 502 may be omitted based on the real design requirement. And the bit stream STR2 is able to be obtained as well by processing a decoding on the decoded data DA8.

### Image Decompression Method

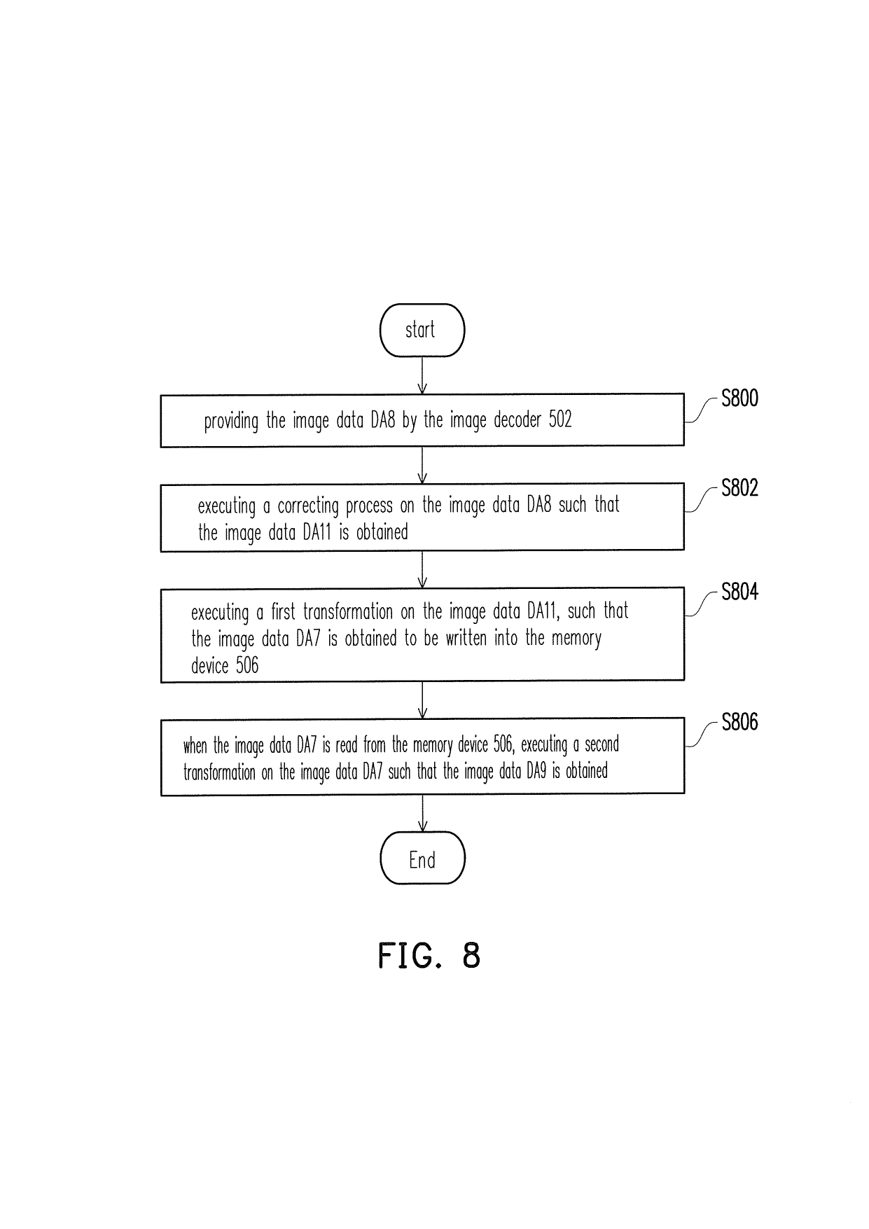

According to the descriptions in the embodiment corresponding to FIG. 5, FIG. 8 is a flowchart of an image processing method according to another exemplary embodiment of the present invention. Referring to FIG. 5 to FIG. 8, the image processing method of the present invention includes following steps. First, the image data DA8 is provided by the image decoder 502 (step S800), wherein the image data DA8 has a plurality of eighth pixel values. Each of the eighth pixel values has an eighth data format, and the eighth data format is not compatible with the dedicated format accessible by the memory device 506.

Next, a correcting process is executed on the image data DA8 such that image data DA11 including a plurality of eleventh pixel values is obtained (step S802), wherein each of the eleventh pixel values is within a predetermined range. Then a first transformation is executed on the image data DA11, such that the image data DA7 is obtained to be written into the memory device 506 (step S804). And each of the image data DA7 has a plurality of seventh pixel values. Each of the seventh pixel values has a seventh data format, and the seventh data format is compatible with the dedicated format accessible by the memory device 506.

Finally, when the image data DA7 is read from the memory device 506, a second transformation is executed on the image data DA7 such that the image data DA9 including a plurality of ninth pixel values is obtained (step S806). Each of the ninth pixel values has a ninth data format, and the ninth data format is not compatible with the dedicated format. The eighth pixel values are substantially corresponding to the ninth pixel values.

In the exemplary embodiment, the implementation of the first and the second transformations in the steps S804 and S806 can be referred to the above-mentioned embodiments. Detail descriptions are not repeated hereinafter.

### Image Compression/Decompression Apparatus

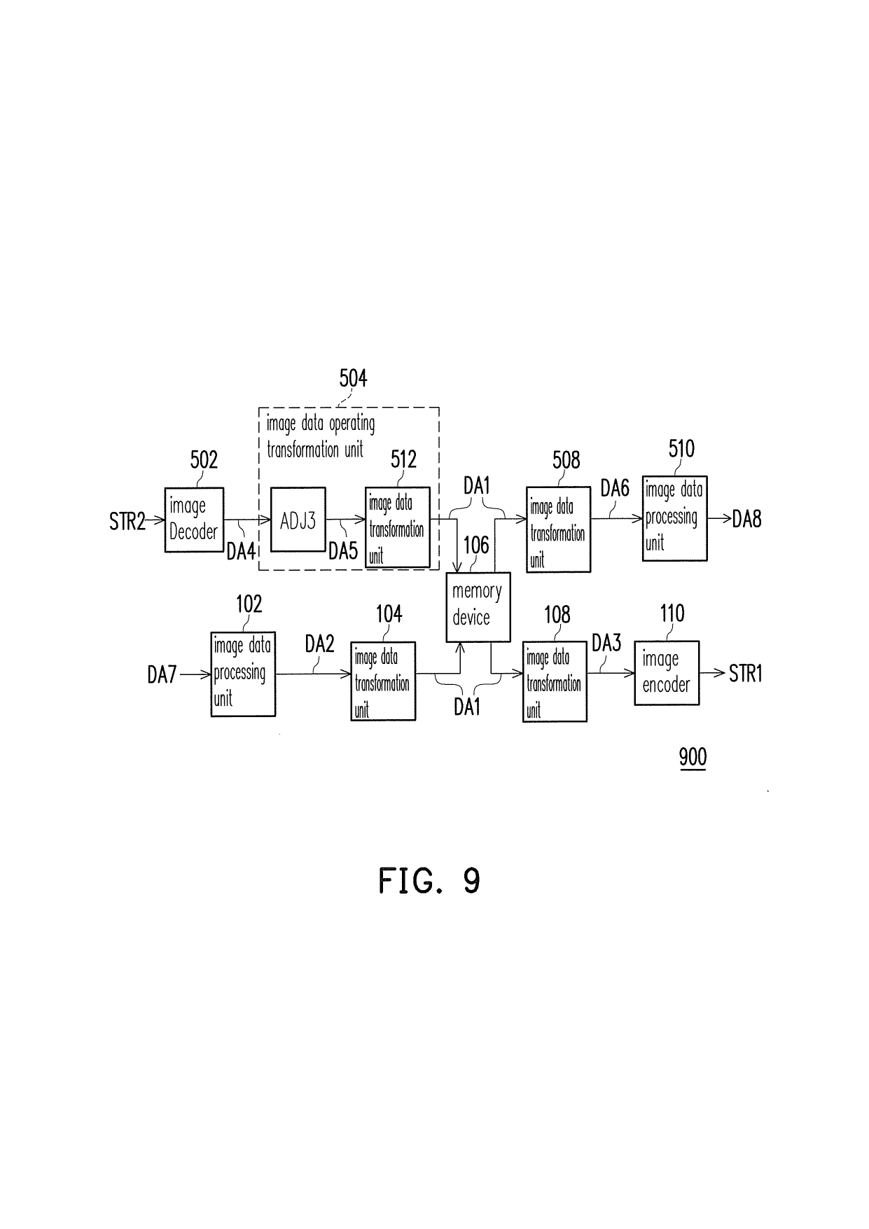

An image processing product usually includes an encoder, a decoder, and a plurality of image data processing units so as to have various functions. FIG. 9 is a block diagram of an image processing apparatus according to another exemplary embodiment of the present invention. Referring to FIG. 9, the memory device 900 for image compression includes the image data processing unit 102, the image data processing unit 104, the image data transformation unit 108, the image encoder 110, and the memory device 106. Besides, the memory device 900 for image decompression includes the image decoder 502, the image data operating transformation unit 504, the image data transformation unit 508, the image data processing unit 510, and the memory device 106. The image data operating transformation unit 504 further includes the operator ADJ3 and the image data transformation unit 512. In other words, memory device 106 commonly is shared by the applications of the image compression and image decompression.

Thus, when the image processing apparatus 900 is used to image compression, the implantations of the image data processing unit 102, the image data transformation units 104 and 108, the image encoder 110, the memory device 106, the image data DA1˜DA3 and DA7, and the bit stream STR1 can be referred to the description of the embodiment corresponding to FIG. 1. Detail descriptions are not repeated hereinafter.

On the other side, when the image processing apparatus 900 is used to image decompression, the implantations of the image decoder 502, the image data processing unit 504, the image data transformation units 508 and 510, the memory device 106, the image data DA1, DA4˜DA6 and DAB, and the bit stream STR2 can be referred to the description of the embodiment corresponding to FIG. 5. Detail descriptions are not repeated hereinafter.

Since the image processing apparatus 900 includes the image compression (encoding) and image decompression (decoding) apparatuses, the relevant steps of the image compression and image decompression carried out by the image processing apparatus 900 can be referred to the descriptions of the embodiments corresponding to FIG. 4 and FIG. 8. A relevant description thereof is thus omitted.

In summary, the image processing apparatus provided by the present invention includes a plurality of image data transformation units. When the data format of the pixel value of the image data is not compatible with the dedicated format accessible by the memory device, the image data transformation unit transforms the data format of the image data into the dedicated format accessible by the memory device. Thus, memory wastage when the image data is written into the memory device is avoided. In addition, after the image data stored in the memory device has been read, another transformation is carried out on the readout image data, such that the data format of each of the image data after the transformations is substantially corresponding to that before the transformations.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An image processing apparatus, comprising:
a memory device, wherein a first pixel value comprising a plurality of first pixel values is written into and read from the memory device, each of the first pixel values has a first data format, and the first data foimat is compatible with a dedicated format accessible by the memory device;
a first image data transformation unit coupled to the memory device, configured to receive a second image data comprising a plurality of second pixel values and process a first transformation, such that the first image data is obtained to be written into the memory device, wherein each of the second pixel values has a second data format, and the second data format is not compatible with the dedicated format; and
a second image data transformation unit coupled to the memory device, reading the first image data from the memory device, and processing a second transformation to obtain a third image data comprising a plurality of third pixel values, wherein each of the third pixel values has a third data format, the third data format is not compatible with the dedicated format, and the second pixel values are substantially corresponding to the third pixel values.

2. The image processing apparatus of claim 1, wherein the first transformation comprises discarding p least significant bits (LSBs) of each of the second pixel values, where p is a positive integer greater than or equal to

3. The image processing apparatus of claim 2, wherein p is 0, 1, 3 or 4.

4. The image processing apparatus of claim 1, wherein the first transformation comprises dividing each of the second pixel values by a first ratio value.

5. The image processing apparatus of claim 4, wherein the first ratio value is 1, 2, 8 or 16.

6. The image processing apparatus of claim 1, wherein the second transformation comprises multiplying each of the first pixel values by a first ratio value.

7. The image processing apparatus of claim 6, wherein the first ratio value is 1, 2, 8 or 16.

8. The image processing apparatus of claim 1 further comprising an image data processing unit coupled to the first image data transformation unit, and configure to receive a fourth image data comprising a plurality of four pixel values and process an image data processing, such that the second image data is obtained.

9. The image processing apparatus of claim 8, wherein the image data processing unit comprises:
a first operator configured to receive the fourth image data and multiply each of the fourth pixel values by a first ratio value, such that a fifth image data comprising a plurality of the fifth pixel values is obtained;
a second operator coupled to the first operator, configured to receive the fifth image data and subtract a first value from each of the fifth pixel values, such that a sixth image data comprising a plurality of sixth pixel values is obtained; and
a color transducer coupled to the second operator, configured to receive the sixth image data and process a color transformation, such that the second image data is obtained.

10. The image processing apparatus of claim 9, wherein the first ratio value is 8.

11. The image processing apparatus of claim 9, wherein the first value is 128 or 1024.

12. The image processing apparatus of claim 8, wherein the image data processing unit comprises:
an operator configured to receive the fourth image data, and multiply each of the fourth pixel values by a first ratio value, such that a fifth image data comprising a plurality of the fifth pixel values is obtained; and
a color transducer coupled to the operator, configured to receive the fifth image data and process a color transformation, such that the second image data is obtained.

13. The image processing apparatus of claim 12, wherein the first ratio value is 8.

14. The image processing apparatus of claim 8, wherein the image data processing unit comprises:
an operator configured to receive the fourth image data and subtract a first value from each of the fourth pixel values, such that a fifth image data comprising a plurality of the fifth pixel values is obtained; and
a color transducer coupled to the operator, configured to receive the fifth image data and process a color transformation, such that the second image data is obtained.

15. The image processing apparatus of claim 14, wherein the first value is 128.

16. The image processing apparatus of claim 1 further comprising an image encoder coupled to the second image data transformation unit, and the image encoder is configured to receive and code the third image data such that a bit stream is obtained.

17. The image processing apparatus of claim 16, wherein the image encoder comprises:
an overlapping converter coupled to the second image data transformation unit, and configured to process a two-level lapped transformation on the third image data such that a first encoded data is obtained;
a quantizer coupled to the overlapping converter, and configured to quantize the first encoded data such that a second encoded data is obtained;
a predictor coupled to the quantizer, and configured to predict the second encoded data such that a third encoded data is obtained; and
an entropy encoder coupled to the predictor, and configured to process an entropy encoding on the third encoded data such that the bit stream is obtained.

18. The image processing apparatus of claim 16, wherein the image encoder comprises:
a color transducer coupled to the second image data transformation unit, and configured to process a color transformation on the third image data such that a fourth encoded data is obtained;
an overlapping converter coupled to the color transducer, and configured to process a two-level lapped transformation on the fourth encoded data such that a first encoded data is obtained;
a quantizer coupled to the overlapping converter, and configured to quantize the first encoded data such that a second encoded data is obtained;
a predictor coupled to the quantizer, and configured to predict the second encoded data such that a third encoded data is obtained; and
an entropy encoder coupled to the predictor, and configured to process an entropy encoding on the third encoded data such that the bit stream is obtained.

19. The image processing apparatus of claim 16, wherein the image encoder unit is a JPEG-XR encoder.

20. An image processing method, comprising:
providing a first image data, wherein the first image data has a plurality of first pixel values, each of the first pixel values has a first data format, and the first data format is not compatible with a dedicated format accessible by a memory device;
executing a first transformation on the first image data such that a second image data is obtained to be written into the memory device, wherein each of the second image data has a plurality of second pixel values, each of the second pixel values has a second data format, and the second data format is compatible with the dedicated format; and when the second image data is read from the memory device, executing a second transformation on the second image data to obtain a third image data comprising a plurality of third pixel values, wherein each of the third pixel values has a third data format, the third data format is not compatible with the dedicated format, and the first pixel values are substantially corresponding to the third pixel values.

21. The image processing method of claim 20, wherein the first transformation comprises discarding p least significant bits (LSBs) of each of the second pixel values, where p is a positive integer greater than or equal to

22. The image processing method of claim 21, wherein p is 0, 1, 3 or 4.

23. The image processing method of claim 20, wherein the first transformation comprises dividing each of the first pixel values by a first ratio value.

24. The image processing method of claim 23, wherein the first ratio value is 1, 2, 8 or 16.

25. The image processing method of claim 20, wherein the second transformation comprises multiplying each of the second pixel values by a first ratio value.

26. The image processing method of claim 25, wherein the first ratio value is 1, 2, 8 or 16.

27. The method of claim 20, further comprising:
providing the third image data to an image encoder.
